(19) United States
(12) Patent Application Publication
(10) Pub. No.: US 2021/0262445 A1
(43) Pub. Date: Aug. 26, 2021

(54) APERTURE TURBINE

(71) Applicant: University of Louisiana at Lafayette, Lafayette, LA (US)

(72) Inventors: Michael Stephen Davis, Lafayette, LA (US); Mohammad R. Madani, Lafayette, LA (US); Raymond Joseph Moreaux, III, Broussard, LA (US)

(21) Appl. No.: 17/186,131

(22) Filed: Feb. 26, 2021

Related U.S. Application Data
(60) Provisional application No. 62/981,665, filed on Feb. 26, 2020.

(51) Int. Cl. F03D 9/25; F03D 1/06

(52) U.S. Cl. CPC F03D 9/25; F05B 2220/7066; F03D 1/0675

(57) ABSTRACT

This invention is an auxiliary wind turbine featuring an aperture. In the preferred embodiment, the device itself is stationary, and mounts onto host objects that move such as wind turbine blades or vehicles. The Aperture Turbine may be oriented on the host object in a plurality of locations to enhance and maximize the intake of kinetic energy from the air moving around and through the Aperture Turbine when in use.

### CROSS REFERENCE TO RELATED APPLICATIONS

This application claims priority to the U.S. Provisional Application No. 62/981,665 entitled “Aperture Turbine” and filed Feb. 26, 2020.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### SUMMARY OF INVENTION

The invention is an auxiliary wind turbine featuring an aperture, which is in communication with a host object. Such host objects may be wind turbine blades or vehicles.

The invention may be oriented on the host object in a plurality of locations to enhance and maximize the intake of kinetic energy from the air moving around and through the invention.

### DESCRIPTION OF THE DRAWINGS

The drawings constitute a part of this specification and include exemplary embodiments of the Aperture Turbine, which may be embodied in various forms. It is to be understood that in some instances, various aspects of the invention may be shown exaggerated or enlarged to facilitate an understanding of the invention. Therefore the drawings may not be to scale.

FIG. 1 is a depiction of the aperture turbine.

FIG. 2 is a section view of the aperture turbine.

### BACKGROUND

Renewable energy is an important, growing, and relevant industry. Increasing efficiency and costs are top priorities to bring renewable energy to the masses. In particular, wind energy power generation and battery charging are two renewable areas that have much room for efficiency improvement.

The current invention is an auxiliary turbine that can be attached or mounted to any number of energy-generating vehicles and devices. The invention harnesses the kinetic energy from wind to create in the first instance or to augment the amount of renewable energy captured.

For example, commercial wind turbine blade tips travel at excess of 150 MPH. But no current devices are aimed at effectively capturing the additional energy at the blade tip. The current invention may mount on the blade tips and results in high electrical power generation gains. Additionally, this device may also be mounted onto electric vehicles to aid in battery charging while the vehicle is in motion by harnessing the kinetic energy of the wind encountering the vehicle.

Accordingly, this invention provides a novel method for capturing or augmenting wind energy.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

The Aperture Turbine is an auxiliary wind turbine featuring an aperture. In the preferred embodiment, the device itself is stationary, and mounts onto host objects that move such as wind turbine blades or vehicles. The Aperture Turbine may be oriented on the host object in a plurality of locations to enhance and maximize the intake of kinetic energy from the air moving around and through the Aperture Turbine when in use.

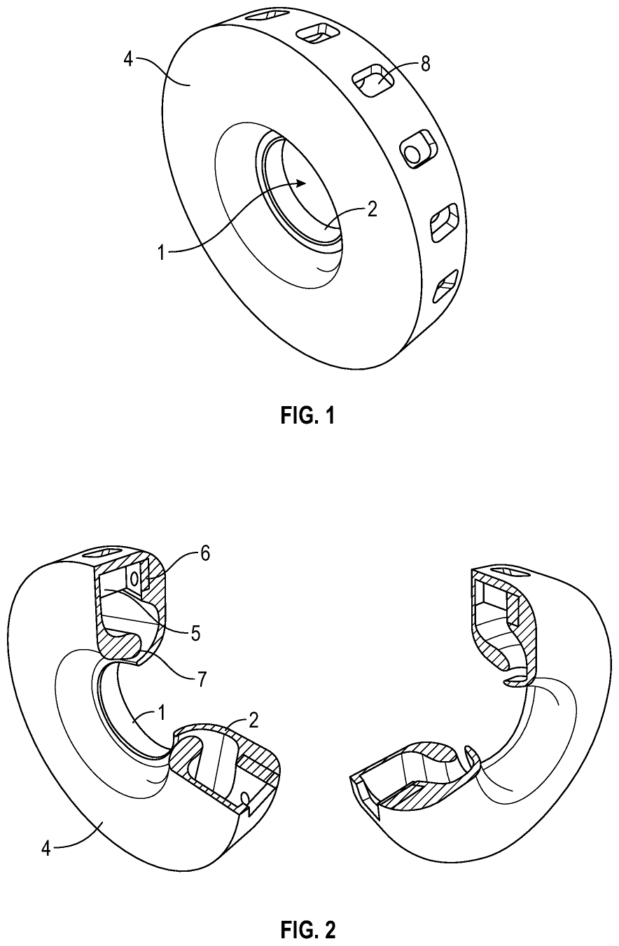

As shown in FIG. 1, the Aperture Turbine comprises an annular cylinder 0. The depicted embodiment comprises concentric circular shapes; however, other shapes may be employed to enhance or differentiate the vortex effect. For instance, ellipsoid or conical shapes may be employed.

As depicted, the annular cylinder comprises a plurality of cavities or side vents 8. In FIG. 1, the cavities are equidistant and located along the outer wall of the annular cylinder. The cavities 8 are substantially rectangular with rounded edges. In other embodiments, the cavities may not be equidistant. In one or more embodiments, the shape of the cavities may be varied.

FIG. 2 shows one embodiment of the various components of the Aperture Turbine. The outer housing 4 and inner housing 2 are shaped, as described above, so as to allow for the conversion of kinetic energy to electricity through the movement of air through the Aperture Turbine. The housing 2, 4 may be made of any suitable material, including plastics or composite materials.

The aperture 1 is shaped as a circular annulus in the center of the Aperture Turbine. In one or more embodiments, the aperture may be non-concentric. In one or more embodiments, the aperture may be non-uniform.

The depicted Aperture Turbine also comprises a generator 6 and turbine blades 5. Any generator 6 and turbine blade 5 configuration may be used, as known in the art.

The depicted Aperture Turbine also comprises wind channels 7. The wind channels 7 are located along the inner circumference or perimeter of the aperture 1. The wind channels 7 may cover a portion of the circumference, or the full circumference. The wind channels 7 are cut out of the outer housing 4 and inner housing 2 and are shaped so as to facilitate air flow through the Aperture Turbine and to the transformation of the kinetic energy. In one embodiment, the wind channels 7 are slit-shaped. In other embodiments, the wind channels 7 may be in other shapes, for example, wider openings, or non-uniform openings.

As the host object moves through the air, air passes through the aperture 1 of the Aperture Turbine 0, creating a vortex effect drawing more air into the aperture 1. Some of this incoming air is channeled into the wind channels 7 where it is forced into the blades 5. The kinetic energy of the rushing air is converted into electricity before exiting the device through the side vents 8.

The Aperture Turbine 0 may also comprise a host connecting means so that the Aperture Turbine 0 may be removably or permanently connected to a mobile, host object.

For the purpose of understanding the Aperture Turbine, references are made in the text to exemplary embodiments of the Aperture Turbine, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

1. An auxiliary turbine comprising:
a. a housing comprising an inner and outer housing;
b. a generator encased within said housing;
c. at least one turbine blade encased within said housing;
d. a plurality of side vents disposed along said housing;
e. at least one wind channel disposed along and through said housing; and
f. a host connection means.

2. The turbine of claim 1 wherein said housing is an annular cylinder.

3. The turbine of claim 1 wherein said plurality of side vents are disposed along the outer housing and are equidistant.

4. The turbine of claim 1 wherein said host is the blade tip of a traditional wind turbine.

5. The turbine of claim 1 wherein said host is an electric vehicle.
